(19) United States
(12) Patent Application Publication
(10) Pub. No.: US 2026/0174195 A1
(43) Pub. Date: Jun. 25, 2026

(54) FAUX WOVEN GARMENT EMBLEM

(71) Applicant: World Emblem International, Inc., Miami, FL (US)

(72) Inventor: Manuel Figueroa, Cooper City, FL (US)

(73) Assignee: World Emblem International, Inc., Miami, FL (US)

(21) Appl. No.: 19/432,377

(22) Filed: Dec. 24, 2025

Related U.S. Application Data
(60) Provisional application No. 63/738,694, filed on Dec. 24, 2024.

(51) Int. Cl. A44C 3/00; B32B 5/02; B32B 5/26; B32B 7/12; G09F 3/10

(52) U.S. Cl. CPC A44C 3/001; B32B 5/022; B32B 5/024; B32B 5/275; B32B 7/12; G09F 3/10; B32B 2250/20; B32B 2262/0276; B32B 2307/7376; B32B 2519/00

(57) ABSTRACT

A faux woven garment emblem having a faux emblem layup of a unitary body and that includes a first layer of a fabric material, with a first upper surface configured to be printed with a design thereon, and a first lower surface opposing the first upper surface, a second adhesive layer of a polymeric material heat-activated, adhesively, and directly coupled to the first lower surface, a third layer of a non-woven fabric material, with a third upper surface directly coupled to the second adhesive layer, and with a third lower surface opposing the third upper surface, and a fourth adhesive layer directly coupled to the third lower surface and configured to adhere the faux emblem layup to a garment.

### FIELD OF THE INVENTION

The present invention relates generally to emblems for garments and, more particularly, embossed and printed emblems.

### BACKGROUND OF THE INVENTION

Fabric emblems are decorative or identifying cloth badges, made by embroidering, weaving, or printing designs onto a fabric base, used on apparel, bags, and uniforms for branding, personal expression, or group affiliation. Known fabric emblems are conventionally applied via sewing, heat-seal backing (iron-on), or adhesive. They range from traditional, raised embroidered patches to modern, flat woven or printed versions with intricate details, often featuring borders and various backings for different application needs.

Many conventional types of woven emblems for garments are made with threads of varying color and thickness in order to generate designs on the emblems. Problematically, however, this process can take an average of five-to-ten days and generally the process and equipment to generate these types of woven emblems are very complex, cumbersome, and expensive. Production of emblems in said manner also conventionally requires at least one hundred minimum pieces of material. Furthermore, producing these conventional types of woven emblems has a larger percentage of rejected pieces in producing said emblems, i.e., approximately 25%, if not greater. These conventional types of woven emblems for garments also have other issues associated with the production, for example, like the emblems losing their shape after production.

Therefore, a need exists to overcome the problems with the prior art as discussed above.

### SUMMARY OF THE INVENTION

The invention provides a faux woven garment emblem that overcomes the hereinafore-mentioned disadvantages of the heretofore-known devices and methods of this general type and that maintains its shape after production, is relatively efficient and effective to generate, and has the appearance and shape comparable to that of a conventional woven emblem for a garment.

With the foregoing and other objects in view, there is provided, in accordance with the invention, a faux woven garment emblem that includes a faux emblem layup of a unitary body and has four layers that includes a first layer of a fabric material, with a first upper surface configured to be printed with a design thereon, and a first lower surface opposing the first upper surface, a second adhesive layer of a polymeric material heat-activated, adhesively, and directly coupled to the first lower surface, a third layer of a non-woven fabric material, with a third upper surface directly coupled to the second adhesive layer, and with a third lower surface opposing the third upper surface, and a fourth adhesive layer directly coupled to the third lower surface and configured to adhere the faux emblem layup to a garment.

In accordance with a further feature of the present invention, the second adhesive layer spans and corresponds in area to the first lower surface and the third upper surface and the fourth layer spans and corresponds in area to the third lower surface.

In accordance with another feature, an embodiment of the present invention includes the first layer and the third layer each having a perimeter edge, wherein the first and third layers are adhesively coupled together with their respective perimeter edges aligned with one another.

In accordance with a yet another feature of the present invention, the first layer is of a synthetic fiber material.

In accordance with an exemplary feature of the present invention, the second adhesive layer is approximately 3 mils in thickness, the third layer is approximately 14 mils in thickness, and the third adhesive layer is approximately 5 mils in thickness. Additionally, the thicknesses of the first, second, third, and fourth layers may also be uniform across a longitudinal width of the respective first, second, third, and fourth layers.

In accordance with a yet another feature of the present invention, the faux emblem layup is of a monolithic body consisting essentially of the first layer, second layer, third layer, and fourth layer.

In accordance with an additional feature of the present invention, the first upper surface includes a digitally modified woven design printed thereon and the digitally modified woven design may include a plurality of dotted indicia printed thereon and a frayed lines at a perimeter edge of the digitally modified woven design and a perimeter edge of the first layer.

Also in accordance with the present invention, a faux woven garment emblem is disclosed that consists essentially of a first layer of a fabric material, with a perimeter edge, with a first upper surface configured to be printed with a design thereon, and a first lower surface opposing the first upper surface, a second adhesive layer of a polymeric material heat-activated, adhesively, and directly coupled to the first lower surface, a third layer of a non-woven fabric material, with a perimeter edge, with a third upper surface directly coupled to the second adhesive layer with the perimeter edge of the third layer aligned with the perimeter edge of the first layer, and with a third lower surface opposing the third upper surface, and a fourth adhesive layer directly coupled to the third lower surface and configured to adhere the faux emblem layup to a garment, the first, second, third, and fourth layers forming a monolithic faux emblem layup.

Although the invention is illustrated and described herein as embodied in a faux woven garment emblem, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not necessarily drawn to scale but, where applicable, may be utilized to support a particular structural configuration or geometric relationship between components utilized in the assembly.

Before the present invention is disclosed and described, it is to be understood that the terminology used herein is for the purpose of describing particular embodiments only and is not intended to be limiting. The terms “a” or “an,” as used herein, are defined as one or more than one, wherein the utilization of “a” or “an” does not mean multiple structures with various functions may be utilized to equate to single claimed structure with claimed functionality. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the emblem or from side-to-side edge of the layer or composite body of the emblem.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective exploded view of layers utilized in a faux woven garment emblem in accordance with one embodiment of the present invention;

FIG. 2 is an exemplary cross-sectional view of the layers of the faux woven garment emblem in FIG. 1 coupled together in accordance with one embodiment of the present invention;

FIG. 3 depicts exemplary designs for the faux woven garment emblem in a process of forming the faux woven garment emblem in accordance with one embodiment of the present invention;

FIG. 4 depicts a top plan view of a faux woven garment emblem with a perimeter border being removed as part of the process of forming the faux woven garment emblem in accordance with one embodiment of the present invention; and

FIG. 5 depicts a top plan view of a final faux woven garment emblem in accordance with one embodiment of the present invention.

### DETAILED DESCRIPTION OF INVENTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient faux woven garment emblem that is unitary in nature, i.e., capable of movement and attachment to a garment as a single piece material and gives a visual appearance of a woven emblem without the cost, time, expense, and errors prone to woven emblems.

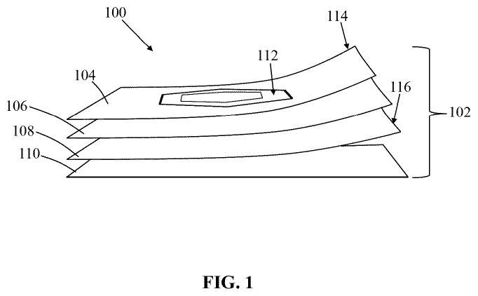

With reference to FIG. 1, one embodiment of the present invention is shown in an exploded view. FIG. 1 shows several advantageous features of the present invention, but, as will be described below, the invention can be provided in several shapes, sizes, combinations of features and components, and varying numbers and functions of the components. The first example of a faux woven garment emblem 100 as shown in FIG. 1 includes faux emblem layup 102, or collection of layers/films 104, 106, 108, 110. In one embodiment, the faux emblem layup 102 includes a first layer 104 of a fabric material configured to be printed thereon, wherein FIG. 1 depicts an exemplary design 112 printed on the first layer 104. The first fabric layer 104 is superimposed over a second adhesive layer 106. The adhesive layer 106 is superimposed over a third layer 108 of a non-woven fabric material, wherein the first and third layers 104, 108 are adhesively coupled to each other with the second adhesive layer 106. The third layer 108 is superimposed over an adhesive layer 110, wherein the adhesive fourth layer 110 is configured to couple (adhere) the faux emblem layup 102 to a garment, e.g., a hat or shirt.

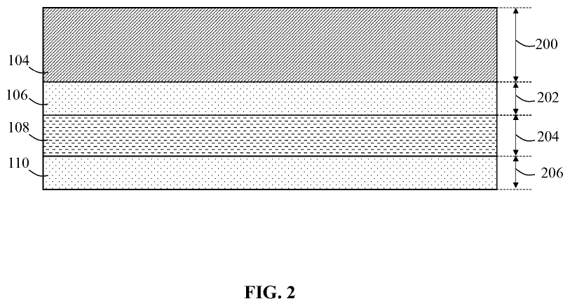

Beneficially, the first layer 104 is of a synthetic fiber material, such as polyester fabric, or other material that is suitable for a digital transfer process called sublimation or direct digitally printed. Said differently, the first layer 104 may be made with a printable fabric that is capable of having a digital print on over it, e.g., 100% recycled polyester. As seen best in FIG. 2, the thickness of the first layer 104 is preferably the remaining selectable thickness 200 required to meet the overall desired total thickness of the faux emblem layup 102. As seen in FIGS. 1-2, the first layer 104 includes a first upper surface configured to be printed with a design thereon and a first lower surface opposing the first upper surface.

In one embodiment, the second adhesive layer 106 is an adhesive film that is preferably composed of a polymeric material. In preferred embodiments, the second adhesive layer 106 is thermoplastic resident that liquifies when heated, i.e., a hot melt adhesive. The second adhesive layer 106 is designed for bonding the first layer 104 with a third layer 108 made of a non-woven fabric material. In one embodiment, the second adhesive layer 106 is a polyurethane film that is activated with heat and is of a thickness 202 of approximately 75 μm or 3 mils (+/−20 μm or +/−2 mil). Said another way, the second adhesive layer 106 remains dry, stable, and tack-free around room temperature and above (i.e., less than 150° F.), allowing the layers to be aligned about their respective edges until a heat (e.g., greater than 180-375° F.) is applied, and preferably with pressure. As such, the second adhesive layer 106 may be directly coupled to the first lower surface and is interposed between the first and third layers 104, 108. The second adhesive layer 106 may span and correspond to the length, width, and area of both the first and third layers 104, 108. Said another way, the second adhesive layer 106 spans and corresponds in area to the first lower surface and the third upper surface and the fourth layer 110 spans and corresponds in area to the third lower surface, thereby providing an effective bond between the layers 104, 108 and the layup 102 with the garment.

In one embodiment, the third layer 108 is a filling material or layer designed to provide rigidity and structural integrity to the faux emblem layup 102. In one preferred embodiment, the third layer 108 is made with a non-woven polyester sheet or other type of fabric that is approximately .1-.6 mm or 14 mils (+/−0.05 mm or +/−10 mils) in thickness 204. In other embodiments, the material of the third layer 108 is PVC sheets, PU sheets, TPU, non-woven polyesters, acrylics, etc. In preferred embodiments, the third layer has the highest flexural or Young's modulus (as measured under ASTM D790) in the layup 200 and preferably has a higher flexural modulus when compared to the first layer 104. The first and third layers 104, 108 each have a perimeter edge 114, 116 (whether in the pre-cut product or the final product) that may be aligned with one another (i.e., overlapping to define a plane that is preferably vertical) when adhesively coupled together (as best exemplified in FIG. 2).

In one embodiment, the fourth adhesive layer 110 is of a thickness 206 of approximately 125 μm or 5 mil (+/−20 μm or +/−3 mil) and is configured for adhering the faux emblem layup 102 to the garment. Said another way, the fourth adhesive layer 110 is directly coupled to the third lower surface. The fourth adhesive layer 110 may be opposite to the first layer 104 on the layup 102 when coupled to the garment material. The fourth adhesive layer 110 is preferably composed of a polymeric material and is also a hot melt adhesive, e.g., a polyurethane film. The fourth adhesive layer 110 may also be a pressure sensitive adhesive film that enables the fourth adhesive layer 110 to adhere the layup 102 to hard or soft surfaces without using any heat, just pressure.

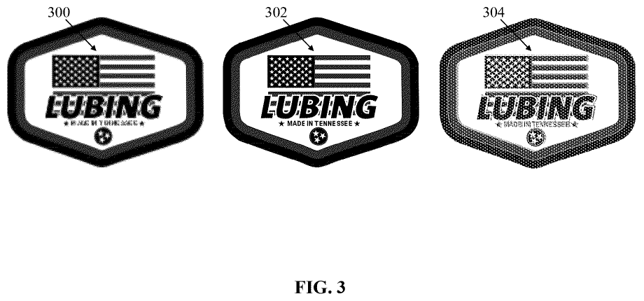

With reference to FIGS. 1-2, a process forming a faux woven garment emblem is described and includes a first step of acquiring or providing a digital image (e.g., images 112, 300) that is going to be placed on the first upper surface of the first layer 104 (e.g., the first image to the left in FIG. 3). This image is routinely provided by a non-manufacturing party. That image is then enhanced by the manufacturer by increasing the resolution (e.g., the second middle image 302 in FIG. 3) and then the image may be resized and placed into the desired shape for further cutting and, importantly, digitally modified to give it the appearance of a real woven patch (e.g., the last image 304 to the right in FIG. 3). This modified digital image having the appearance of a woven design, i.e., threading that is a faux design, will be digitally printed on a transfer paper (for heat transfer process to the first layer 104) or printed directly to the first upper surface of the first layer 104 (for direct to print process). This digitally modified woven design may be created by utilizing dotted indicia and frayed lines at the edges generating an appearance of threading and/or a woven emblem.

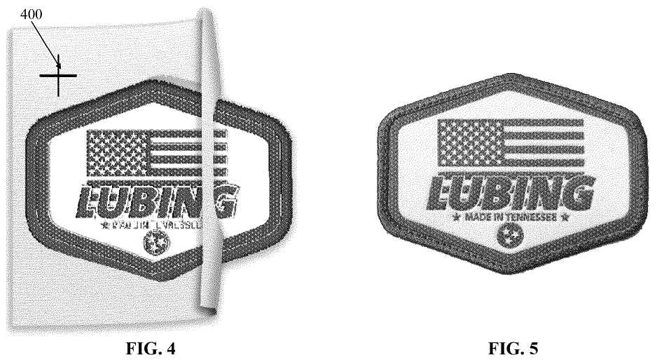

Thereafter, the process may include a step of using some of the elements from the digital design (e.g., outlines) for creation of a digital file that will be used to carve a metal die that will facilitate in giving the first upper surface an embossed appearance and/or raised/lowered surfaces. Next, the process may include digitally printing said final design onto a transfer paper or printed direct to the first upper surface of the fabric first layer 104. A set of “registration marks” (exemplified in FIG. 4) will also be printed to ensure the fabric registers the die in the embossed process. The metal die, having also the “registration marks”, will be carved using a CNC machine. Next, a sandwich, created with the different layers of materials will be stacked together and precut in single units, i.e., the faux emblem layup 102.

The stacked materials will preferably be placed into a high frequency (HF) machine and register with the attached die so as to be exposed to heat, pressure, and time. Using the right settings on the HF machine, the material will be pressed to give the product an embossed look. If needed, another die will be created to cut the product into the final shape. The finished product can also have a decorative border using different technologies like embroidery machine, merrow border machine or others. With reference to FIG. 4, the process may include cutting/removing a border around the design, forming a custom perimeter and design thereon (FIG. 5). In one embodiment, the process may also include applying a polymeric transfer paper over the fourth adhesive layer 110 for removal before application to a garment.

The HF range is based on the overall size of the patch, but it may be modified to ensure the machine archives a bonded faux woven appearance. In one embodiment, the HF machine settings include waiting time of 3-4 seconds, pre-welding time of 1.5-2.5 seconds, welding time of 1.5-2.5 seconds, cooling time of 4-6 seconds, pressure of 250-450 psi, and potency of 65-80 kW. Total thickness for the faux emblem layup 102 may range from approximately 0.9-1.3 mm. In preferred embodiments, the faux emblem layup 102 is of a monolithic body consisting essentially of the first layer, second layer, third layer, and fourth layer.

Although a specific order of executing the process steps has been described and depicted, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A faux woven garment emblem comprising:
a faux emblem layup of a unitary body and including:
a first layer of a fabric material, with a first upper surface configured to be printed with a design thereon, and a first lower surface opposing the first upper surface;
a second adhesive layer of a polymeric material heat-activated, adhesively, and directly coupled to the first lower surface;
a third layer of a non-woven fabric material, with a third upper surface directly coupled to the second adhesive layer, and with a third lower surface opposing the third upper surface; and
a fourth adhesive layer directly coupled to the third lower surface and configured to adhere the faux emblem layup to a garment.

2. The faux woven garment emblem according to claim 1, wherein the second adhesive layer spans and corresponds in area to the first lower surface and the third upper surface and the fourth layer spans and corresponds in area to the third lower surface.

3. The faux woven garment emblem according to claim 1, wherein the first layer and the third layer each further comprise:
a perimeter edge, wherein the first and third layers are adhesively coupled together with their respective perimeter edges aligned with one another.

4. The faux woven garment emblem according to claim 1, wherein the first layer is of a synthetic fiber material.

5. The faux woven garment emblem according to claim 4, wherein the second adhesive layer is approximately 3 mils in thickness, the third layer is approximately 14 mils in thickness, and the third adhesive layer is approximately 5 mils in thickness.

6. The faux woven garment emblem according to claim 5, wherein the thicknesses of the first, second, third, and fourth layers are uniform across a longitudinal width of the respective first, second, third, and fourth layers.

7. The faux emblem layup according to claim 1, wherein the faux emblem layup is of a monolithic body consisting essentially of the first layer, second layer, third layer, and fourth layer.

8. The faux emblem layup according to claim 1, wherein the first upper surface includes a digitally modified woven design printed thereon.

9. The faux emblem layup according to claim 8, wherein the digitally modified woven design includes a plurality of dotted indicia printed thereon and a frayed lines at a perimeter edge of the digitally modified woven design and a perimeter edge of the first layer.

10. A faux woven garment emblem consisting essentially of a:
a first layer of a fabric material, with a perimeter edge, with a first upper surface configured to be printed with a design thereon, and a first lower surface opposing the first upper surface;
a second adhesive layer of a polymeric material heat-activated, adhesively, and directly coupled to the first lower surface;
a third layer of a non-woven fabric material, with a perimeter edge, with a third upper surface directly coupled to the second adhesive layer with the perimeter edge of the third layer aligned with the perimeter edge of the first layer, and with a third lower surface opposing the third upper surface; and
a fourth adhesive layer directly coupled to the third lower surface and configured to adhere the faux emblem layup to a garment, the first, second, third, and fourth layers forming a monolithic faux emblem layup.

11. The faux woven garment emblem according to claim 10, wherein the second adhesive layer spans and corresponds in area to the first lower surface and the third upper surface and the fourth layer spans and corresponds in area to the third lower surface.

12. The faux woven garment emblem according to claim 10, wherein the first layer is of a synthetic fiber material.

13. The faux woven garment emblem according to claim 12, wherein the second adhesive layer is approximately 3 mils in thickness, the third layer is approximately 14 mils in thickness, and the third adhesive layer is approximately 5 mils in thickness.

14. The faux woven garment emblem according to claim 13, wherein the thicknesses of the first, second, third, and fourth layers are uniform across a longitudinal width of the respective first, second, third, and fourth layers.

15. The faux woven garment emblem according to claim 10, wherein the first upper surface includes a digitally modified woven design printed thereon.

16. The faux emblem layup according to claim 15, wherein the digitally modified woven design includes a plurality of dotted indicia printed thereon and a frayed lines at a perimeter edge of the digitally modified woven design and a perimeter edge of the first layer.
